(19) United States
(12) Patent Application Publication
(10) Pub. No.: US 2008/0052631 A1
(43) Pub. Date: Feb. 28, 2008

(54) SYSTEM AND METHOD FOR EXECUTING SERVER APPLICATIONS IN MOBILE TERMINAL

(76) Inventors: Seung Han CHOI, Gyeonggi (KR); Dong Myung SUL, Daejeon (KR); Kyung Hee LEE, Daejeon (KR); Seung Min PARK, Daejeon (KR); Heung Nam KIM, Daejeon (KR); Jae Myoung KIM, Daejeon (KR); Chae Deok LIM, Daejeon (KR); Sun Ja KIM, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/833,694

(22) Filed: Aug. 3, 2007

(30) Foreign Application Priority Data
Aug. 23, 2006 (KR) 10-2006-0079973

(51) Int. Cl. G06F 3/00

(52) U.S. Cl. 715/740

(57) ABSTRACT

Provided is a system for executing applications stored in an application server on a mobile terminal. The mobile terminal includes: a mobile terminal input/output processing unit for processing data input via an input device of the mobile terminal and data to be output via an output device thereof; a mobile terminal information transmitting and receiving unit for transmitting and receiving data to and from the outside via an Internet network; and a data processing unit for decoding the structural data received from the mobile terminal information transmitting and receiving unit and sending the decoded data to the mobile terminal input/output processing unit, or encoding data received from the mobile terminal input/output processing unit and sending the encoded data to the mobile terminal information transmitting and receiving unit. The application server includes an application storage unit for storing an application to be executed by the mobile terminal; a server information transmitting and receiving unit for transmitting and receiving data to and from the outside via the Internet network; and a server application managing unit for performing and controlling configuration management of registering, modifying or deleting the application information to be executed at the mobile terminal, and converting a result of executing the application to be output to the output device of the mobile terminal.

### CROSS-REFERENCE TO RELATED APPLICATION

This application claims priority to and the benefit of Korean Patent Application No. 2006-79973, filed Aug. 23, 2006, the disclosure of which is incorporated herein by reference in its entirety.

### BACKGROUND

1. Field of the Invention

The present invention relates to a system for executing remote server applications in a mobile terminal, and more particularly, to a system for executing applications installed in a remote server, converting the execution results into data suitable for execution in a mobile terminal, and transmitting the data to the mobile terminal.

2. Discussion of Related Art

In recent years, with the advent of a variety of multimedia applications including moving-image processing applications, audio reproducing applications, and Internet telephone applications, and with extensive use of wireless Internet, there is growing demand among users to execute multimedia and other applications on mobile terminals, such as cellular phones, personal digital assistants (PDAs), and mobile personal computers (PCs). Executing applications, however, requires a high-performance mobile terminal whose hardware and software is expensive. To solve this problem, a remote server executes applications installed therein, converts the execution results into data suitable for execution at a mobile terminal, and transmits the data to the mobile terminal so that the mobile terminal processes the execution result, thereby reducing a software cost of the mobile terminal.

One related technique is disclosed in Korean Patent Application No. 2001-0069531 entitled “Method and Apparatus for Receiving and Sending a data from and to Computer in Using Mobile PC.” The apparatus comprises a mobile personal computer (PC), a wireless Internet server, and a personal computer connected to the Internet. The method includes steps of accessing, by the mobile PC, the personal computer via the wireless Internet server when the personal computer is selected; applying, by the wireless Internet server, a capture signal to the personal computer to capture a frame of a screen displayed on a monitor of the personal computer; capturing, by the personal computer, the frame of the screen displayed on the monitor in response to the capture signal received from the wireless Internet server and converting the frame into data; sending, by the personal computer, the data to the wireless Internet server by streaming; sending, by the wireless Internet server, the data from the personal computer to the mobile PC; and converting, by the mobile PC, the data received from the wireless Internet server into an image signal to be displayed on the monitor via a screen output unit.

In this technique, a stationary screen and related information of the personal computer is periodically transmitted to the mobile terminal, but real-time multimedia information such as voice information, audio information or moving-image information is not processed. Further, since the apparatus delivers an entire screen displayed on the personal computer, having a size suitable for resolution of the personal computer, to the mobile terminal, for example, the shapes and sizes of characters, icons, etc. may be distorted when displayed on the mobile terminal.

### SUMMARY OF THE INVENTION

The present invention is directed to implementation of a system and method enabling a mobile terminal to control the selection and execution of an application stored in an application server using a mobile terminal managing unit and a server managing unit, and allowing the application server to convert the execution results into data based on specification information of the mobile terminal or a user's selection, and output the data to the mobile terminal.

One aspect of the present invention provides a system for allowing a mobile terminal to execute an application stored in an application server, wherein the mobile terminal comprises a mobile terminal input/output processing unit for processing data input via an input device of the mobile terminal and data to be output via an output device thereof; a mobile terminal information transmitting and receiving unit for transmitting and receiving data to and from the outside via an Internet network; and a data processing unit for decoding structural data received from the mobile terminal information transmitting and receiving unit and sending the decoded data to the mobile terminal input/output processing unit, or encoding data received from the mobile terminal input/output processing unit and sending the encoded data to the mobile terminal information transmitting and receiving unit, and the application server comprises an application storage unit for storing an application to be executed by the mobile terminal; a server information transmitting and receiving unit for transmitting and receiving data to and from the outside via the Internet network; and a server application managing unit for performing and controlling configuration management of registering, modifying or deleting the application information to be executed at the mobile terminal, and converting a result of executing the application to be output to the Output device of the mobile terminal.

The data processing unit of the mobile terminal may comprise a display data processing unit for transmitting application management screen information and application execution screen information of the application server from the mobile terminal information transmitting and receiving unit to the mobile terminal input/output processing unit; an input data processing unit for sending input information of the mobile terminal from the mobile terminal input/output processing unit to the mobile terminal information transmitting and receiving unit; a user data processing unit for sending user information, display specification information, and audio, video or voice codec specification information of the mobile terminal to the mobile terminal information transmitting and receiving unit; an Internet telephone data processing unit for sending the voice information from the mobile terminal information transmitting and receiving unit to the mobile terminal input/output processing unit or the voice information from the mobile terminal input/output processing unit to the mobile terminal information transmitting and receiving unit; an audio data processing unit for sending the audio information from the mobile terminal information transmitting and receiving unit to the mobile terminal input/output processing unit; and a moving-image data processing unit for sending the moving-image information from the mobile terminal information transmitting and receiving unit to the mobile terminal input/output processing unit.

The server application managing unit may be connected to a user information managing unit for sending display specification information and audio, video or voice codec specification information of the mobile terminal from the server information transmitting and receiving unit to the server application managing unit, or receiving the user information of the mobile terminal from the server information transmitting and receiving unit to perform user authentication; a display managing unit for sending the application management screen information and the application execution screen information from the server application managing unit to the server information transmitting and receiving unit; an input managing unit for sending the input information of the mobile terminal from the server information transmitting and receiving unit to the server application managing unit; an Internet telephone managing unit for sending the voice information from the server information transmitting and receiving unit to the server application managing unit or sending voice information processed by an Internet telephone application from the server application managing unit to the server information transmitting and receiving unit; an audio managing unit for sending the audio information from the server application managing unit to the server information transmitting and receiving unit; and a moving-image managing unit for sending the moving-image information from the server application managing unit to the server information transmitting and receiving unit.

Another aspect of the present invention provides a method for allowing a mobile terminal to execute an application stored in an application server, the method comprising the steps of: (a) transmitting specification information of the mobile terminal or user input information of the mobile terminal to the application server via an Internet network; (b) analyzing, by the application server, the received specification information of the mobile terminal or user input information of the mobile terminal; (c) executing, by the application server, a specific application based on the analyzing result; (d) converting management screen information or execution screen information of the application to suitable for an output device of the mobile terminal, based on the specification information of the mobile terminal or the user input information of the mobile terminal; and (e) sending the converted management screen information or execution screen information of the application to the output device of the mobile terminal.

### BRIEF DESCRIPTION OF THE DRAWINGS

The above and other objects, features and advantages of the present invention will become more apparent to those of ordinary skill in the art by describing in detail preferred embodiments thereof with reference to the attached drawings in which:

FIG. 1 illustrates a connection between a mobile terminal and an application server according to an exemplary embodiment of the present invention;

FIG. 2 illustrates a configuration of the mobile terminal and the application server of FIG. 1;

FIG. 3 illustrates the structure of a mobile terminal managing unit;

FIG. 4 illustrates the structure of a server managing unit; and

FIG. 5 illustrates processes performed by a server application managing unit.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various modified forms. The exemplary embodiments are described to make this disclosure complete and fully enabling of practice of the present invention by those of ordinary skill in the art.

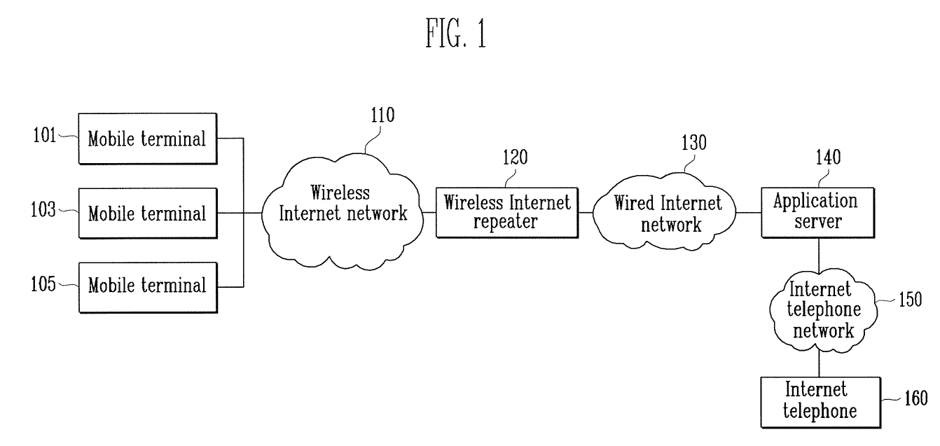

FIG. 1 illustrates a connection between a mobile terminal and an application server according to an exemplary embodiment of the present invention.

Referring to FIG. 1, a system includes a plurality of mobile terminals 101, 103 and 105, an application server 140, a wireless Internet network 110 and a wired Internet network 130 for connecting between the mobile terminals 101, 103 and 105 and the application server 140, and a wireless Internet repeater 120 for connecting between the wireless Internet network 110 and the wired Internet network 130. The system further includes an Internet telephone network 150 connected to the application server 140, and an Internet telephone 160.

Each of the mobile terminals 101, 103 and 105 includes a personal digital assistant (PDA), a cellular phone, a mobile PC, or the like and is equipped with a wireless LAN card or a Bluetooth device for allowing the terminal to use the wireless Internet.

The mobile terminals 101, 103 and 105 access the wired Internet network 130 via the wireless Internet network 110 in order to access the application server 140 connected to the wired Internet network 130, in which the wireless Internet repeater 120 is used to connect between the wireless Internet network 110 and the wired Internet network 130. The mobile terminal 101, 103 or 105 instructs the application server 140 to execute applications, such as a moving-image processing application, an audio reproducing application, and an Internet telephone execution application, via the wired/wireless Internet networks, receives results of executing the applications via the wired/wireless Internet network, and outputs the results.

The application server 140 receives a command to execute the application from the mobile terminal 101, 103 or 105, executes the application, converts the execution results to be suitable for the mobile terminal 101, 103 or 105, and provides the execution results. The application server 140 includes a computer connected to the wired/wireless Internet network and capable of executing and processing multimedia applications, such as a moving-image reproducing application, an audio reproducing application, and an Internet telephone execution application.

The Internet telephone 160 is a communication device capable of transmitting a packetized voice signal over the Internet telephone network 150. The telephone has a unique IP address assigned for allowing a user to communicate with a user of another Internet telephone, a PC on the Internet, or the mobile terminal 101 of the present invention.

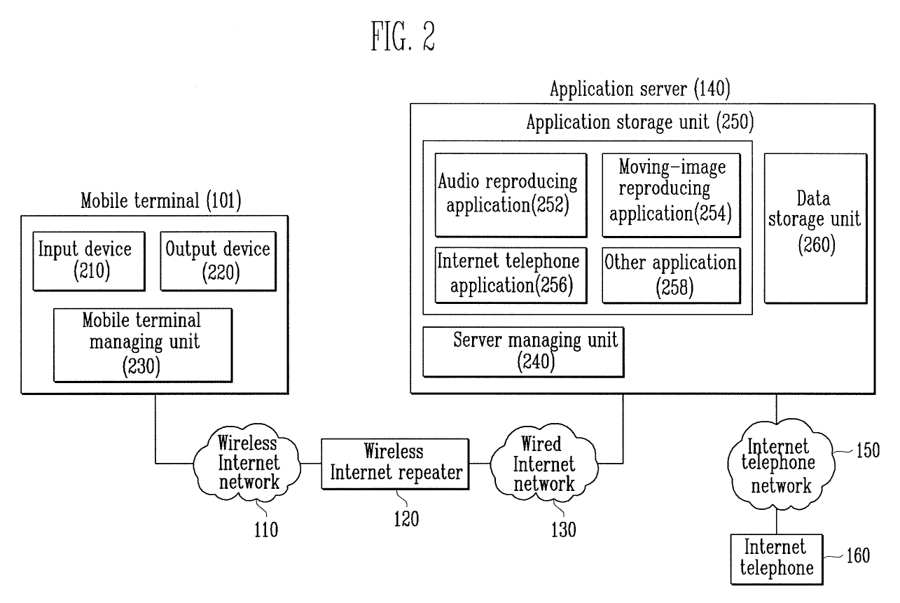

FIG. 2 illustrates the configuration of the mobile terminal 101 and the application server 140 of FIG. 1.

Referring to FIG. 2, the mobile terminal 101 includes an input device 210, an output device 220, and a mobile terminal managing unit 230, and the application server 140 includes a server managing unit 240, an application storage unit 250, and a data storage unit 260.

In the mobile terminal, the input device 210 includes a keypad, a touch screen, and a microphone that a user uses to input data to the mobile terminal 101. The output device 220 includes a display monitor, a speaker, and an ear phone used to output processing results of the mobile terminal 101. A touch screen monitor widely used as a monitor for a mobile terminal, such as a PDA, serves as the input device 210 as well as the output device 220.

In response to a selection, by a user with the input device 210 of the mobile terminal, of an application stored in the application storage unit 250 of the application server 140, the mobile terminal managing unit 230 generates an execution signal and transmits the signal to the application server 140 via the wired/wireless Internet networks 130 and 110. The mobile terminal managing unit 230 receives the execution results from the application server 140 and sends the execution results to the output device 220 of the mobile terminal.

Meanwhile, data is subjected to voice codec decoding, moving-image codec decoding, or the like by the applications 252, 254, 256 and 258 in the application server 140, and is encoded into structural data to be sent over the Internet network together with synchronization information of the mobile terminal. The mobile terminal managing unit 230 receives and decodes the encoded data. Since compressed data such as moving-image data greatly burdens hardware resources when decoded, it is decoded by the external application server 140, and in this case, the mobile terminal 101 merely receives and displays the processing results. The synchronization information will be described later.

Meanwhile, the application server 140 includes the application storage unit 250 for storing an audio reproducing application 252, a moving-image reproducing application 254, an Internet telephone application 256, and other application 258; and the data storage unit 260 for storing voice/audio data, image/moving-image data, etc.

The application storage unit 250 and the data storage unit 260 may be hard disks, magnetic tapes, or the like. The applications 252, 254, 256 and 258 serve to process the data stored in the data storage unit 260 in response to a control signal from the server managing unit 240 and send the processing results to the server managing unit 240.

The server managing unit 240 selects one of the applications and sends an execution command in response to a data processing request signal received from the mobile terminal managing unit 230 of the mobile terminal over the wireless/wired Internet networks 110 and 130. The server managing unit 240 receives the processing results and sends them to the mobile terminal managing unit 230 over the wired/wireless Internet networks 130 and 110. Prior to sending the processing results, the server managing unit 240 encodes the processing results into structural data to be sent to the Internet network together with the synchronization information for the mobile terminal.

A method for executing applications will now be described.

For example, when a user inputs an execution command signal to execute a specific moving-image reproducing application stored in the application server 140 via the input device 210 of the mobile terminal, the mobile terminal managing unit 230 sends the execution command signal over the wireless/wired Internet networks 110 and 130 to the server managing unit 240 of the application server 140. In response to the received execution command, the server managing unit 240 instructs the moving-image reproducing application 254 stored in the application storage unit 250 to execute. The moving-image reproducing application 254 selects a suitable codec, decodes the data stored in the data storage unit 260 using the codec, and sends the processing results to the sever managing unit 240. The server managing unit 240 encodes the moving-image data processing results into a structural data suitable for transmission over the Internet network together with the synchronization information for the mobile terminal, and sends the structural data to the mobile terminal managing unit 230 of the mobile terminal 101 over the wired/wireless Internet networks 130 and 110. The mobile terminal managing unit 230 decodes the received data and sends it to the output device 220. The transmitted data is output by the output device 220.

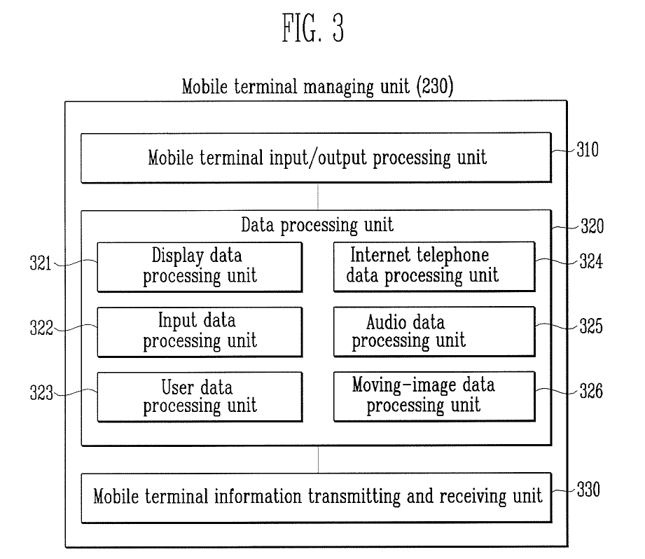

FIG. 3 illustrates a structure of the mobile terminal managing unit 230.

Referring to FIG. 3, the mobile terminal managing unit 230 includes a mobile terminal input/output processing unit 310, a data processing unit 320, and a mobile terminal information transmitting and receiving unit 330. The data processing unit 320 includes a display data processing unit 321, an input data processing unit 322, a user data processing unit 323, an Internet telephone data processing unit 324, an audio data processing unit 325, and a moving-image data processing unit 326.

The mobile terminal input/output processing unit 310 serves to receive a signal input by a user through the input device 210 of the mobile terminal and send it to a corresponding processing unit in the data processing unit 320, or to send data processed by the application server 140 to the output device 220 of the mobile terminal.

For example, the mobile terminal input/output processing unit 310 sends information from the input device 210, such as a touch screen, of the mobile terminal to the input data processing unit 322 in the data processing unit 320, and sends the application management screen information and the application screen information of the application server 140 received from the display data processing unit 321 to the output device 220, such as a monitor, of the mobile terminal. The mobile terminal input/output processing unit 310 also sends voice information from the input device 210, such as a microphone, of the mobile terminal to the Internet telephone data processing unit 324, and sends voice information processed by the application server 140 and received from the Internet telephone data processing unit 324 to the output device 220, such as the speaker or the ear phone, of the mobile terminal. The mobile terminal input/output processing unit 310 also sends audio information received from the audio data processing unit 325 to the output device 220, such as a speaker, of the mobile terminal, and sends the moving-image information from the moving-image data processing unit 326 to the output device 220, such as a monitor, of the mobile terminal.

Meanwhile, the data processing unit 320 decodes the structural data and sends the decoded data to the mobile terminal input/output processing unit 310 so that moving-image information, voice information, audio information or another type of data received from the application server 140 via the mobile terminal information transmitting and receiving unit 330 is output via the output device 220 of the mobile terminal, or encodes the data input via the input device 210 of the mobile terminal into structural data and transmits the structural data to the application server 140 via the mobile terminal information transmitting and receiving unit 330. The structural data must be encoded before being transmitted via the Internet network in order to be transmitted without loss, and a receiving side needs to decode the data in order to check for loss.

To process different types of data, the data processing unit 320 includes the display data processing unit 321, the input data processing unit 322, the user data processing unit 323, the Internet telephone data processing unit 324, the audio data processing unit 325, and the moving-image data processing unit 326, as described above.

The display data processing unit 321 decodes application management screen information and application execution screen information as the structural data of the application server 140 received from the mobile terminal information transmitting and receiving unit 330, and sends the decoded data to the mobile terminal input/output processing unit 310 to be displayed on the screen of the mobile terminal. The data received from the application server 140 includes information about the application execution screen displaying a data execution state of the application and information about the application management screen such as a window manager screen displaying a management state for the execution of the application on the application server 140, as well as the results of processing various moving image and audio data stored in the data storage unit 260. Accordingly, the display data processing unit 321 can output the data execution results via the output device 220 of the mobile terminal and display the application execution screen or application management screen on the monitor of the mobile terminal.

For example, when the moving-image data is to be executed, the moving image execution application stored in the application server 140 is selected and executed. The moving-image data processed by the moving image execution application, i.e., data decoded by a moving image compressing codec, is received and output via the moving-image data processing unit 326 and the mobile terminal input/output processing unit 310. In addition, the information on the application management screen and the moving image execution application execution screen, which display moving-image data selection and execution processes, is displayed via the display data processing unit 321 and the mobile terminal input/output processing unit 310.

The input data processing unit 322 encodes input information of the mobile terminal received from the mobile terminal input/output processing unit 310 into structural data, and sends the structural data to the mobile terminal information transmitting and receiving unit 330. The input data processing unit 322 processes signals input via the input device 210 of the mobile terminal, i.e., a keypad, a touch screen or a microphone.

The user data processing unit 323 encodes the user information, display specification information, and audio, video or voice codec specification information of the mobile terminal into structural data, and sends the structural data to the mobile terminal information transmitting and receiving unit 330. In addition, the user data processing unit 323 receives user authentication information from the mobile terminal information transmitting and receiving unit 330 and allows the mobile terminal 101 to maintain a connection with the application server 140.

The Internet telephone data processing unit 324 decodes a correspondent's structural voice information received from the mobile terminal information transmitting and receiving unit 330 and sends it to the mobile terminal input/output processing unit 310. In addition, the Internet telephone data processing unit 324 encodes user voice information received from the mobile terminal input/output processing unit 310 into structural data and sends it to the mobile terminal information transmitting and receiving unit 330. After an Internet telephone connection is established, the Internet telephone data processing unit 324 establishes an Internet telephone bypass connection to the application server in order to directly receive voice information from a correspondent's telephone on the Internet, not via the application server.

The bypass connection refers to a direct connection between the mobile terminal and the Internet telephone 160 via the Internet network rather than the application server. Establishment of the bypass connection requires an encoder for compressing voice transmitted from the mobile terminal to the Internet telephone 160, and a decoder for decompressing voice data in a compressed form received from the Internet telephone 160. That is, the encoder and the decoder are required to implement the bypass function and satisfy a real-time requirement for Internet telephones.

Accordingly, when the bypass function is executed, the Internet telephone data processing unit 324 encodes the voice information input via the mobile terminal input device 210 into structural data, and decodes voice information as the structural data received from the Internet telephone 160 via the mobile terminal information transmitting and receiving unit 330 by means of a specific codec.

The audio data processing unit 325 decodes the audio information as the structural data received from the mobile terminal information transmitting and receiving unit 330, and sends the decoded data to the mobile terminal input/output processing unit 310.

The moving-image data processing unit 326 decodes the moving-image information as the structural data received from the mobile terminal information transmitting and receiving unit 330 and sends the decoded data to the mobile terminal input/output processing unit 310. The moving-image data processing unit 326 synchronizes the application execution screen information displayed on the mobile terminal based on the moving image display synchronization information in the moving-image information.

For the synchronization information, when a moving image is reproduced by an application such as a “window media reproducing”, a skin portion of the application surrounding a moving-image reproducing portion becomes the execution screen information of the application, which is processed by the above-described display processing unit 321. In this case, the moving image must be reproduced to correspond to a display position of the monitor for the mobile terminal. For this, the application server 140 sends moving-image information containing coordinates on the mobile terminal at which the application execution screen information is displayed. The display location of the moving-image information is specified by the coordinates, i.e., synchronization information.

Meanwhile, the mobile terminal information transmitting and receiving unit 330 converts control signals, voice information, and the like input via the input device 210 of the mobile terminal 101 into structural data so that they are transmitted via the Internet network, and sends the data to the application server 140. In addition, the mobile terminal information transmitting and receiving unit 330 receives a structural data containing audio information, moving-image information, display information, or voice information processed by various applications from the application server 140, and sends the structural data to the data processing unit 320. Since the structural data received from the application server 140 contains an identifier for a feature of the data, the mobile terminal information transmitting and receiving unit 330 reads the identifier to check the feature of the received data, and sends the data to a corresponding data processing unit of the data processing unit 320 depending on the feature. For example, the mobile terminal information transmitting and receiving unit 330 sends the received data to the moving-image data processing unit 326 when the data is moving-image information, to the Internet telephone data processing unit 324 when it is voice information, and to the audio data processing unit 325 when it is audio information.

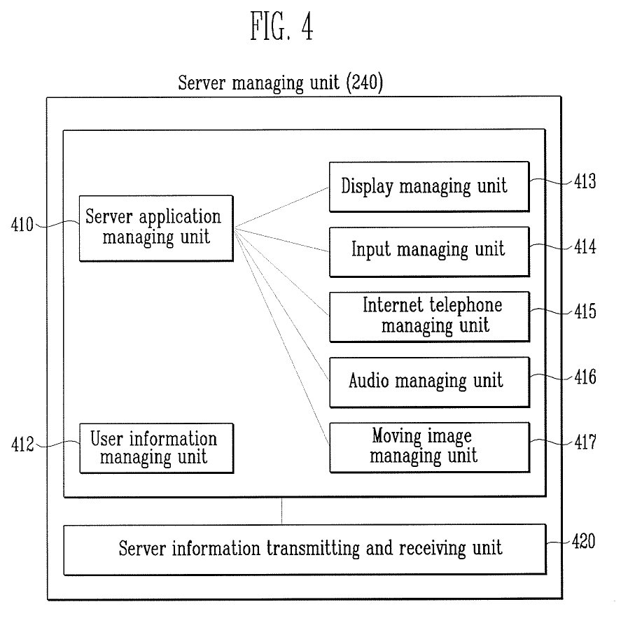

FIG. 4 illustrates a structure of the server managing unit 240.

Referring to FIG. 4, the server managing unit 240 includes a server application managing unit 410, and a server information transmitting and receiving unit 420. The server application managing unit 410 is connected to the user information managing unit 412, the display managing unit 413, the input managing unit 414, the Internet telephone managing unit 415, the audio managing unit 416, or the moving image managing unit 417.

The server application managing unit 410 performs configuration management of registering, modifying or deleting application information for the mobile terminal and controls the configuration management. With the server application managing unit 410, the user of the mobile terminal can directly compose necessary applications.

Specifically, the server application managing unit 410 generates information about an application management screen which displays a process of selecting and executing specific data or an application at the mobile terminal, and information about an application execution screen which displays a scene of executing the selected data or application.

Information about selection of the specific data or application is input through the input managing unit 414. When the user selects specific data or an application through the input device 210 of the mobile terminal while viewing the application management screen information, the selection information is sent to the server information transmitting and receiving unit 420 of the application 20 server via the mobile terminal input/output processing unit 310, the input data processing unit 321, and the mobile terminal information transmitting and receiving unit 330, and, in turn, to the server application managing unit 410 via the input managing unit 414.

Further, when the server application managing unit 410 analyzes the user-input information and sends the analyzing result to a corresponding application, the application analyzes the input information to modify the application management screen information or the application execution screen information or to generate new application management screen information or application execution screen information. The modified or newly generated information is sent to the display managing unit 413 and output via the server information transmitting and receiving unit 420 to be displayed on the output device 220 of the mobile terminal.

Meanwhile, generation of the application management screen information or the application execution screen information may require display specification information and audio, video or voice codec specification information of the mobile terminal. The server application managing unit 410 receives such information from the user information managing unit 412.

Further, the server application managing unit 410 sends results of executing various applications included in the server to the Internet telephone managing unit 415, the audio managing unit 416, or the moving image managing unit 417. When sending moving-image information from the moving image application to the moving image managing unit 417, the server application managing unit 410 generates and sends synchronization information for synchronization with the moving image application execution screen information displayed on the mobile terminal. The server application managing unit 410 also sends audio information from the audio application to the audio managing unit 416. The server application managing unit 410 sends the voice information received from the Internet telephone managing unit 415 to the Internet telephone application and, reversely, the voice information processed by the Internet telephone application to the Internet telephone managing unit 414.

The user information managing unit 412 performs configuration management for registering, modifying, and deleting user information about mobile terminal, and analyzes the user information received from the server information transmitting and receiving unit 420 to check whether the user is authenticated and send the result to the server information transmitting and receiving unit 420. Further, the user information managing unit 412 receives the display specification information and audio, video and voice codec specification information of the user's mobile terminal from the server information transmitting and receiving unit 420 and sends the information to the server application managing unit 410.

The display managing unit 413 encodes the application management screen information and the application execution screen information received from the server application managing unit 410 into structural data to be delivered via the Internet, and sends the structural data to the server information transmitting and receiving unit 420.

The input managing unit 414 receives, via the server information transmitting and receiving unit 420, the signal that the user of the mobile terminal inputs using the input device 210, decodes the signal, and sends the decoded signal to the server application managing unit 410. The signal input using the input device 210 includes information about an icon shape, a font type and a window size, directly composed by the user, for the application management screen displayed on the mobile terminal, selection and execution information for specific data, selection and execution information for a specific application, etc.

The Internet telephone managing unit 415 decodes the voice information as the structural data received from the server information transmitting and receiving unit 420 and sends the decoded data to the server application managing unit 410 so that the data is processed by the Internet telephone application. Further, the Internet telephone managing unit 415 receives the voice information processed by the Internet telephone application via the server application managing unit 410 and sends the voice information to the server information transmitting and receiving unit 420. In this case, after an Internet telephone connection is established, the Internet telephone managing unit 415 may perform an Internet telephone bypass connection on the application server in order to directly receive the voice information from a correspondent's device on the Internet, not via the application server.

When the bypass function is executed, session processing for direct connection between the mobile terminal and the Internet telephone is directly performed by the Internet telephone application in the application server, and a voice information encoding and decoding process is performed by the mobile terminal. The Internet telephone managing unit 415 sends the session processing information for direct connection between the mobile terminal and the Internet telephone to the Internet telephone application via the server application managing unit 410 when the bypass function is executed.

The audio managing unit 416 encodes the audio information received from the server application managing unit 410 into structural data and sends the structural data to the server information transmitting and receiving unit 420.

The moving image managing unit 417 encodes the moving-image information and information about synchronization with the application execution screen received from the server application managing unit 410 into structural data, and sends the structural data to the server information transmitting and receiving unit 420.

Meanwhile, the server information transmitting and receiving unit 420 receives input information, voice information and user information included in the structural data from the mobile terminal, and sends them to the input managing unit 414, the Internet telephone managing unit 415, and the user information managing unit 412, respectively. Since the structural data received from the mobile terminal 101 includes an identifier for a feature of the data, the server information transmitting and receiving unit 420 reads the identifier to check the feature of the received data and transmits the data to a co-responding managing unit depending on the feature. For example, the server information transmitting and receiving unit 420 sends the received data to the input managing unit 414 when the data is the input information, to the Internet telephone managing unit 415 when the data is the voice information, and to the user information managing unit 412 when the data is the user information. Further, the server information transmitting and receiving unit 420 sends the display information, the audio information, the moving-image information, the voice information, or the user information from the Internet telephone managing unit 415, the audio managing unit 416, the moving-image managing unit 417, the user information managing unit 412, or the display managing unit 413 to the mobile terminal.

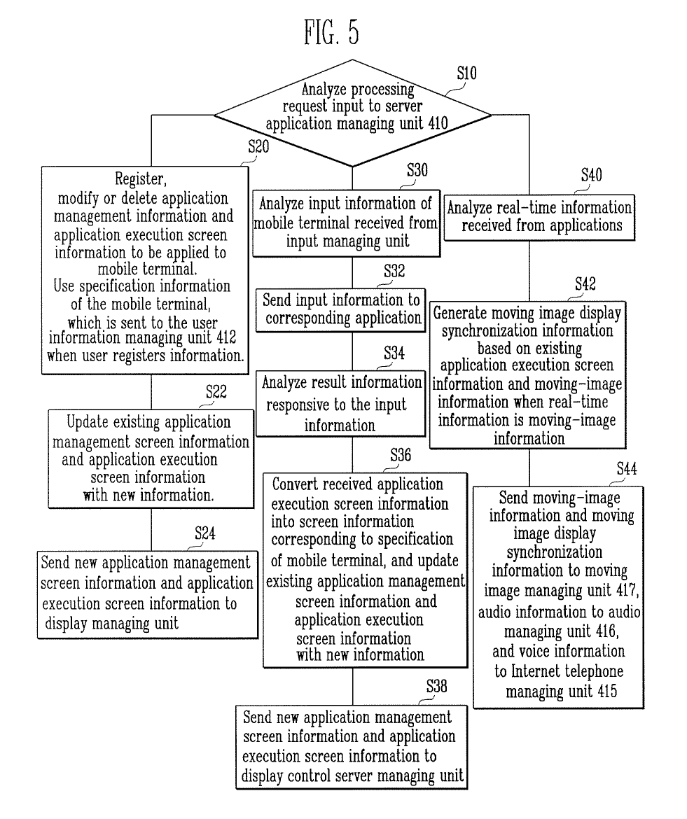

FIG. 5 illustrates processes performed by the server application managing unit 410.

When an external processing request is input, the server application managing unit 410 analyzes the processing request (S10).

First, the server application managing unit 410 may be an application allowing a user to directly register, modify or delete application management information and application execution screen information to be applied to the mobile terminal. With the application, the user can directly confirm the composed application screen information, such as an icon shape, a font type, or a window size. When the user directly inputs the screen information, the server application managing unit 410 determines the application screen information based on display specification information of the mobile terminal, which is sent to the user information managing unit 412 (S20).

When there is modified application management screen information and application execution screen information, the server application managing unit 410 updates existing application management screen information and application execution screen information (S22).

The new application management screen information and application execution screen information is sent to the display managing unit 413 and then to the mobile terminal via the server information transmitting and receiving unit 420 (S24).

Second, the server application managing unit 410 analyzes input information of the mobile terminal received from the input managing unit 414 (S30) and sends it to a corresponding application (S32). The results of processing the input information at the application are sent to the server application managing unit 410. The server application managing unit 410 analyzes the result information (S34) to obtain application execution screen information, which is converted into application execution screen information reflecting an icon shape, a window size or a font type for the mobile terminal. The existing application management screen information and application execution screen information are then updated with new information (S36) and sent to the display control server managing unit (S38).

Third, the server application managing unit 410 identifies and analyzes real-time information including audio information, moving-image information, and voice information received from the applications (S40). When the real-time information is the moving-image information, the server application man aging unit 410 generates moving image display synchronization information based on the existing application execution screen information and moving-image information (S42). The server application managing unit 410 then sends the moving-image information and the moving image display synchronization information to the moving image managing unit 417, the audio information to the audio managing unit 416, and the voice information to the Internet telephone managing unit 415 (S44).

With the system and method for allowing a mobile terminal to execute server applications according to the present invention, a mobile terminal such as a smart phone or a PDA can perform, without applications installed therein, information processing using hardware of an application server, which may be a personal computer or a home server, and software such as server applications, and the results of processing the information at the server are simply sent to the mobile terminal so that the information is displayed, thereby reducing costs for software installation and maintenance in the mobile terminal.

In addition, a user is allowed to construct a server application for the mobile terminal, compose fonts, icons, and screens suitable for the mobile terminal, and send them to the mobile terminal. Furthermore, real-time information such as voice information, audio information or moving-image information can be processed by a variety of applications in the application server and the results of processing the information can be send to the mobile terminal.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A system for executing applications stored in an application server on a mobile terminal wherein:
the mobile terminal comprises:
a mobile terminal input/output processing unit for processing data input via an input device of the mobile terminal and data to be output via an output device thereof;
a mobile terminal information transmitting and receiving unit for transmitting and receiving data to and from the outside via an Internet network; and
a data processing unit for decoding the structural data received from the mobile terminal information transmitting and receiving unit and sending the decoded data to the mobile terminal input/output processing unit, or encoding data received from the mobile terminal input/output processing unit and sending the encoded data to the mobile terminal information transmitting and receiving unit, and
the application server comprises:
an application storage unit for storing an application to be executed by the mobile terminal;
a server information transmitting and receiving unit for transmitting and receiving data to and from the outside via the Internet network; and
a server application managing unit for performing and controlling configuration management of registering, modifying or deleting the application information to be executed at the mobile terminal, and converting a result of executing the application to be output to the output device of the mobile terminal.

2. The system of claim 1, wherein the data processing unit of the mobile terminal comprises:
a display data processing unit for transmitting application management screen information and application execution screen information of the application server from the mobile terminal information transmitting and receiving unit to the mobile terminal input/output processing unit;
an input data processing unit for sending input information of the mobile terminal from the mobile terminal input/output processing unit to the mobile terminal information transmitting and receiving unit;
a user data processing unit for sending user information, display specification information, and audio, video or voice codec specification information of the mobile terminal to the mobile terminal information transmitting and receiving unit;
an Internet telephone data processing unit for sending the voice information from the mobile terminal information transmitting and receiving unit to the mobile terminal input/output processing unit or the voice information from the mobile terminal input/output processing unit to the mobile terminal information transmitting and receiving unit;
an audio data processing unit for sending the audio information from the mobile terminal information transmitting and receiving unit to the mobile terminal input/output processing unit; and
a moving-image data processing unit for sending the moving-image information from the mobile terminal information transmitting and receiving unit to the mobile terminal input/output processing unit.

3. The system of claim 2, wherein the Internet telephone data processing unit comprises:
an encoding unit for compressing the voice information input via the input device of the mobile terminal; and
a decoding unit for decompressing the compressed voice information input via the mobile terminal information transmitting and receiving unit.

4. The system of claim 1, wherein the server application managing unit is connected to:
a user information managing unit for sending display specification information and audio, video or voice codec specification information of the mobile terminal from the server information transmitting and receiving unit to the server application managing unit, or receiving the user information of the mobile terminal from the server information transmitting and receiving unit to perform user authentication;
a display managing unit for sending the application management screen information and the application execution screen information from the server application managing unit to the server information transmitting and receiving unit;
an input managing unit for sending the input information of the mobile terminal from the server information transmitting and receiving unit to the server application managing unit;
an Internet telephone managing unit for sending the voice information from the server information transmitting and receiving unit to the server application managing unit or sending voice information processed by an Internet telephone application from the server application managing unit to the server information transmitting and receiving unit;
an audio managing unit for sending the audio information from the server application managing unit to the server information transmitting and receiving unit; and
a moving-image managing unit for sending the moving-image information from the server application managing unit to the server information transmitting and receiving unit.

5. The system of claim 4, wherein the server application managing unit generates synchronization information containing coordinates of a point on a display monitor of the mobile terminal at which an execution screen of a moving-image reproducing application is located, and sends the synchronization information to the moving image managing unit.

6. The system of claim 4, wherein the server application managing unit converts the application management screen information or application execution screen information to be output to the output device of the mobile terminal, based on the specification information of the mobile terminal received from the user information managing unit.

7. The system of claim 4, wherein the server application managing unit converts the application management screen information or application execution screen information to be output to the output device of the mobile terminal, based on the user input information of the mobile terminal received from the input managing unit.

8. The system of claim 4, wherein the Internet telephone managing unit sends session processing information for direct connection between the mobile terminal and an external Internet telephone to an Internet telephone application via the server application managing unit.

9. A method for executing applications stored in an application server on a mobile terminal, the method comprising the steps of:
(a) transmitting specification information of the mobile terminal or user input information of the mobile terminal to the application server via an Internet
(b) analyzing, by the application server, the received specification information or user input information of the mobile terminal;
(c) executing, by the application server, a specific application based on the analyzing result;
(d) converting management screen information or execution screen information of the application to be suitable for an output device of the mobile terminal, based on the specification information of the mobile terminal or the user input information of the mobile terminal; and
(e) sending the converted management screen information or execution screen information of the application to the output device of the mobile terminal.

10. The method of claim 9, wherein step (b) comprises the step of performing user authentication based on the user information of the mobile terminal.

11. The method of claim 9, wherein step (c) comprises the step of executing an Internet telephone application, an audio reproducing application, or a moving-image reproducing application stored in the application server, based on the analyzing result.

12. The method of claim 9, wherein step (d) comprises the step of converting the management screen information or execution screen information of the application, based on a result of executing the Internet telephone application, audio reproducing application, or moving-image reproducing application stored in the application server.
